(19) United States
(12) Patent Application Publication
(10) Pub. No.: US 2007/0203865 A1
(43) Pub. Date: Aug. 30, 2007

(54) Apparatus and methods for an item retrieval system

(76) Inventor: Martin Christian Hirsch, Marburg (DE)

Correspondence Address: 24IP LAW GROUP USA, PLLC, 12 E. LAKE DRIVE, ANNAPOLIS, MD, 21403, US

(21) Appl. No.: 11/350,095

(22) Filed: Feb. 9, 2006

(51) Int. Cl. G06N 5/02

(52) U.S. Cl. 706/46

(57) ABSTRACT

An apparatus (440) for use in an information retrieval system is described. The apparatus comprises a processor (500) and a memory (410) storing a plurality of information elements. The memory (410) stores a plurality of connections (117; 313, 315, 317) between at least two of the plurality of information elements (110, 115; 210) to form an element connection (100; 220; 310); one or more gestalts (230; 320) comprising a plurality of the information elements (110, 115; 210) related to each other and one or more asset-profiles (240; 330) comprises a plurality of the information elements (110, 115; 210) with weighted values. The information elements (110, 115; 210) can either represent concepts in a document, pixels in an image or one or more parts of a frame model. A method for use in an information retrieval system is also described. This method comprises a first step of creating at least one connection (117; 313, 315, 317) between at least two of the information elements (110, 115; 210) representing information to form at least one element connection (100; 220; 310), a second step of creating at least one gestalt (230; 320) from at least two information elements (110, 115; 210) with a common relationship and a third step of creating at least one asset-profile (240; 330) from at least two information elements (110, 115; 210) and assigning each of the at least two information elements (110, 115; 210) a weighted value.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND OF THE INVENTION

1. Field of the Invention

The invention relates to apparatus and accompanying methods for machine based information retrieval processes.

2. Brief Description of the Related Art

The increasing use of computers to store and process data have caused massive amount of information to be available. Much of this information is in the form of electronic documents and in various formats, e.g. Microsoft Word, Excel, PDF, PostScript, to name just a few. Unfortunately, the sheer volume of the information available makes it impossible to locate and process information by manual means. It is therefore necessary to develop automated means for locating or retrieving documents, organising and categorising the documents as well as processing the documents so that the information becomes useful.

Various techniques of data mining—as the retrieval of useful information from the documents is termed—are known. For example, International Patent Application No WO-A-02/10985 (Tenara Ltd) teaches a method of and system for automatic document retrieval, categorisation and processing. This patent application discloses a system and method which using semantic networks to process the documents. The document is converted into a list of terms and applying a stemming algorithm to the list of terms, looking up in a network each resulting stem to determine all senses possibly referring to each stem, applying an algorithm to select the likely interpretations for each set of senses, calculating the most likely interpretation being the correct interpretation and returning the most likely interpretation for the document.

German Patent Application DE-A-102 00 172 (IP Century) teaches a method and system for the textual analysis of patent documents in which a matrix is constructed from the terms in the patent documents. The application of these matrices is, however, not disclosed in this patent application.

U.S. Pat. No. 6,839,702 (Patel et al, assigned to Google) teaches a search system for searching documents distributed over a network. The system generates a search query that includes a search terms and, in response to the search query, receives a list of one or more references to documents in the network. The system receives selection of one of the references and retrieves the documents that corresponds to the selected reference. The system then highlights the search term in the retrieved document.

U.S. Pat. No. 6,470,333 (Baclawski) teaches a method of warehousing documents which is conducive to knowledge extraction. In this system, an object, such as a document, is downloaded onto a warehousing node. The warehousing node extracts some features from the document. The features are then fragmented into feature fragments and then hashed and stored on the network.

U.S. Pat. No. 5,933,822 (Braden-Harder et al, assigned to Microsoft) teaches an apparatus and method for an information retrieval system that employs natural language processing of the search results in order to improve the overall precision of the search defined by a user-supplied query. The documents in the search result are subjected to natural language processing in order to produce a set of logical forms. The logical forms include, in a word-relation-word manner semantic relationships between the words in a phrase. The user-supplied query is analysed in the same manner to yield a set of corresponding logical forms for the user-supplied query. The documents are ranked as a predefined function of the logical forms from the documents and the user-defined query. This is done by coparing the set of logical forms for the query agains a set of logical forms for each of the retrieved documents in order to ascertain a match between any such logical forms in both sets. Each of the documents that has at least one matching logical form is heuristically scored with each different relation for a matching logical form being assigned a different corresponding pre-defined weight. The score of each document is, for example, a pre-defined function fo the weights of its uniquely matching logical forms. Finally the documents are ranked and presented to the user.

U.S. Pat. No. 6,453,315 (Weisman et al, assigned to Applied Semantics) teaches a meaning-based organisation and retrieval system which relies on the idea of a meaning-based search allowing users to locate information that is close in meaning to the concepts that the user is searching. A semantic space is created by a lexcon of concepts and relations between concepts. A query is mapped to a first meaning differentiator, representing the location of the query in the semantic space. Similarly each data element in the target data set being searched is mapped to a second meaning differentiator which represents the location of the data element in the semantic space. Searching is accomplished by determining a semantic distance between the first meaning differentiator and the second meaning differentiator, wherein the distance represents their closeness in meaning.

Finally, US Patent Application Publication US-A 2004/0243395 (Gluzberg et al, assigned to Holtran Technology Ltd) teaches another method and system for processing, storing, retrieving an presenting information. This system provides an extendable interface for natural and artificial languages. The system includes an interpreter, a knowledge base and an input/output module. The system stores information in the knowledge base based on the sorted-type theory.

The patent document above all relate to the analysis of text in order to process the information. However, similar problems occur, for example, when trying to analyse images. Suppose, for example, a robot is trying to analyse its environment. It needs to process the information about its whereabouts in an efficient and accurate manner in order for it to perform useful tasks. Such cognition methods are known which enable robots to interact with their environment. However these current methods cannot be used to process text.

There remains a need for a fast and associative retrieval method within machines that takes into account the actual situation via context and focus, works as well with fragment of pictures as with units of 3D-models or words from texts or bigger and heterogeneous groups of these elements, and is able to formulate hypotheses about how high ranked elements may fit together.

### SUMMARY OF THE INVENTION

The present invention satisfies this need by creating a fast, memory based association processor utilizing priming methods to represent the context, spreading methods to execute the retrieval, path-finding methods to create assemblies of elements and cascading methods to rank assemblies of elements with known relations (gestalten) or unknown relations (asset profiles).

An apparatus for use in an information retrieval system in accordance with a preferred embodiment of the present invention comprises a processor and a memory storing a plurality of information elements, wherein the memory further stores a plurality of connections between at least two of the plurality of information elements to form an element connection, one or more gestalts comprising a plurality of the information elements related to each other, and one or more asset-profiles comprises a plurality of the information elements with weighted values.

A method for use in an information retrieval system in accordance with a preferred embodiment of the present invention comprises a first step of creating at least one connection between at least two of the information elements representing information to form at least one element connection, a second step of creating at least one gestalt from at least two information elements with a common relationship, and a third step of creating at least one asset-profile from at least two information elements and assigning each of the at least two information elements a weighted value.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 depicts the structures of an element-triple.

FIG. 2 depicts the items of the association processor.

FIG. 3 depicts the organisation of the triple-layer, the gestalt-layer and the asset-layer.

FIG. 4 depicts a block diagram of the association processor's environment.

FIG. 5 depicts a high-level block diagram of the processes within the association processor.

FIG. 6 depicts a flow chart with the principle steps of the priming process.

FIG. 7 depicts a flow chart with the principle steps of the spreading process.

FIG. 8 depicts a primed triple-layer, the status during spreading and an activated triple-layer.

FIG. 9 depicts a simple path-finding and path-ranking process in the triple-layer.

FIG. 10 depicts a simple cascading- and ranking process.

### DETAILED DESCRIPTION OF THE PREFERRED EMBODIMENTS

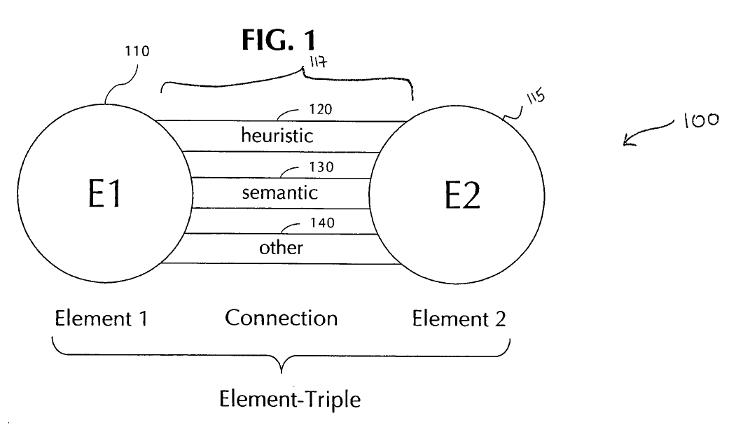

In FIG. 1 the structure of an element-triple 100 is illustrated graphically. Each element-triple comprises a first element 110 and a second element 115 with a connection 117. The first element 110 or the second element 115 of the element-triple 100 can be a concept, a piece of a digital picture or a part of a digital 3D-wireframe-model. The invention is described with respect to element-triples. However, it could be equally applicable to any other form of connections between first elements 110 and second elements 115 (collectively termed information elements).

A concept is a representative for the meaning of a word. To take one example: the concept “Parkinsonian Disease” stands for 42 nouns which all mean Morbus Parkinson (Morbus Parkinson, Parkinsons Disease, Parkinsons, etc.). “Parkinsonian Disease” is a synonym for all of these nouns and thus “Parkinsonian Disease” is a concept. Another concept could be “Dopamine” which means all systematic and common names for a particular type of chemical compound (e.g. 3,4-dihydroxyphenylehtlyamine, 3hydroxytyramine, etc.). The pixels that form the mouth in a digital photo of a face is an example of a piece of a digital picture. The wireframe model part of the eye in the wireframe model of the head is an example of a part of a digital 3D-wireframe-model. The connection 117 can be either a heuristic connection 120, a semantic connection 130 or another type of connection 140. The connection 117 is a balanced mixture of the three types of the connection 117.

The heuristic connection 120 means that the relation between the first element 110 and the second element 115 is based on experience. If the first element 110 and the second element 115 have a high co-occurence rate in the world (for example “shoes” and “socks”) or in a plurality of documents (for example the concept Parkinsonian Disease and the concept Dopamine in papers published in academic journals), then it can be concluded that the first element 110 and the second element 115 will have a semantic connection. In this case the heuristic connection is a statistical connection between the first element 110 and the second element 115. The heuristic connection 120 will also be high, if both the weight of the first element 110 and the weight of the second element 115 are high. This means that both the weight of the first element 110 and the weight of the second element are “activated” in a given situation and a connection between the first element 110 and the second element 115 is perceived via a sensory input. This can be best illustrated by a further example: if you eat a peach with a strange taste and you have to regurgitate the peach, then the taste and the regurgitation are connected highly. The first element 110 (i.e. the peach) and the second element 115 (i.e. regurgitating) are activated. The weight of the connection is high and will be the case even if the statistical connection (i.e. how often you had this experience) is small. Thus both the first element 110 (eating of the peach) and the second element 115 (regurgitation) are activated at the same time.

The heuristic connection may also be high, if there is a single article in the literature that describes the connection between the first element 110 and the second element 115 (in this case the statistical distance based on co-occurrence would be quite high) but the journal in which this single article was published is deemed to be of high value for a user. This could be because the journal is highly rated (e.g. Nature, New England Journal of Medicine or PNAS) or because it is of particular relevance in the field. It should be understood that there may be more than one heuristic connection 120 between the first element 110 and the second element 115.

If the first element 110 and the second element 115 are concepts, the semantic connection 130 is a grammatically correct and meaningful connection between the first element 110 and the second element 115. If the first element 110 and the second element 115 are pieces of a picture the semantic connection 130 maybe an aesthetic, a meaningful or a recalled relation between the two pieces of the picture (or attributes). If the first element 110 and the second element 115 are parts of a 3D-wireframe-model the semantic connection 130 maybe a geometric, an aesthetic or a meaningful or a recalled relation between these two parts. Normally there is more than one semantic connection 130 between the first element 110 and the second element 115.

The other connection 140 means that the connection 117 is neither the heuristic connection 120 nor the semantic connection 130. The other connection 140 could be, but is not limited to, a hypothetical connection assigned by the user (or the machine) or a connection the user is not allowed to see or an unknown connection. There may be more than one other connection 140 between the first element 110 and the second element 115.

This combination of the different types of the connection 117 allows a flexible construction of associative networks: the sum of the semantic connections 130 forms a common semantic network. The sum of the heuristic connections 120 can be regarded as a pre-semantic network representing events and constellations of objects in the environment of the machine.

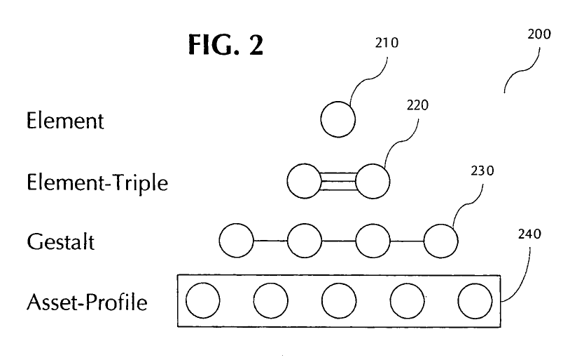

In addition to the element-triple 100 there are three more elements. These are shown in FIG. 2. As described above the element 210 can be either a concept, a piece of a picture or a part of a 3D-model. A “gestalt” 230 is an assembly of more than one element 210. Each ones of the elements 210 have an explicit and known connection between each of them. An asset-profile 240 is an assembly of more than one element 210 representing an asset. The asset can be, but is not limited to, a document, a data set, a picture or a complex 3D model. In the asset-profile 240 the connections between the ones of the elements 210 are unknown and each of the elements 210 are assigned with at least one factor that characterizes the importance of this element 210 for the representation of the asset. The simplest asset-profile 240 is a list of concepts representing the content of a document (it will be recalled that the document is an example of an asset). Each concept in the document is assigned with a factor representing the relative importance of the concept for the meaning of the document (rdf/idf-weights). To take an example, a document describing the connection between Parkinson's Disease and treatment in clinics might have factors which indicate that it is important as a reference work for Parkinsonian Disease but the equivalent factor for the concept (element) “clinic” would be set lower because the document was not so important relating to clinical treatment of Parkinsonian disease.

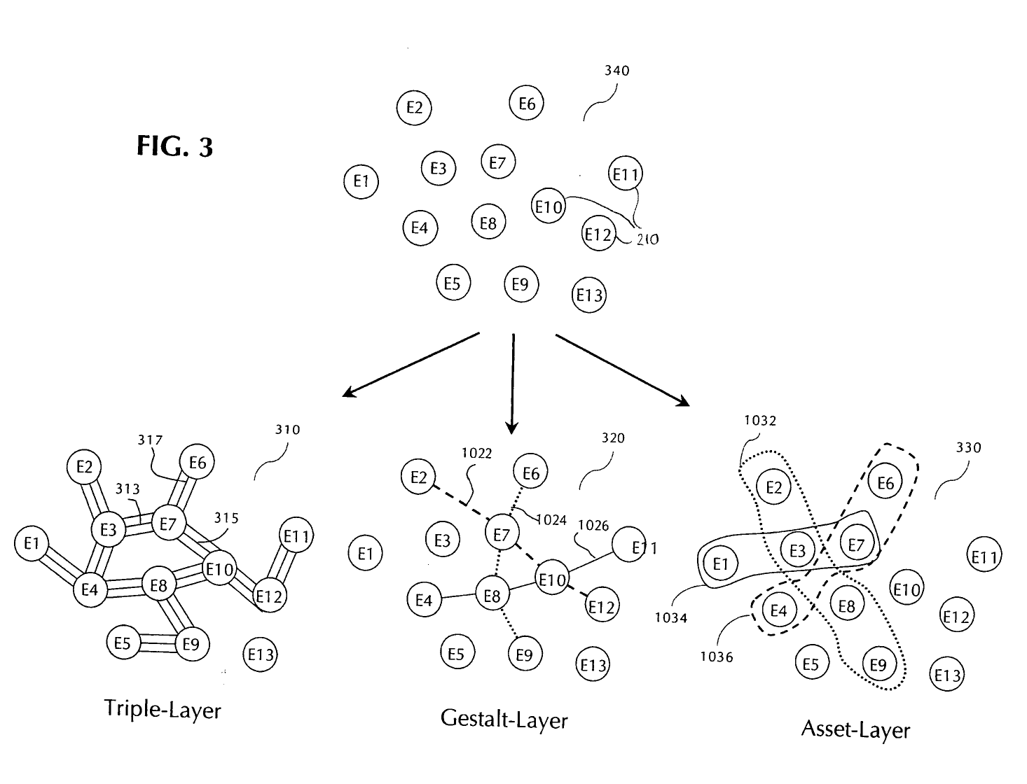

FIG. 3 shows how elements 210 are organized. There is a predefined set 340 of elements 210. Each two of the elements 210 can be connected via an element-triple 220. For example the element E7 is linked to the element E3 via the connection 313, to the element E6 via the connection 317 and to the element E10 via the connection 315. The group of all the element-triples 220 is called a triple-layer 310 and is shown in FIG. 3. The elements 210 can be linked by a gestalt 230. For example the element E6 is linked to the element E7, the element E8 and the element E9 via gestalt 1024. The group of all the gestalts 230 is called a gestalt-layer 320 and is shown in FIG. 3. The elements 210 can be linked via an asset-profile 240. For example the element E6 is linked to the element E7 and the element E4 via asset-profile 1034. The group of all asset-profiles is called asset-layer 330 and is shown in FIG. 3. Each ones of the elements 210 can be part of one or more different groups. For example, the element E6 is part of the element-triple 312, part of the gestalt 1024 and part of the asset-profile 1036. The connections 117 between two of the elements 210 can represent different types of relations. The resulting network is neither a pure semantic network nor a pure statistical network—it is termed a relation network. The triple layer 310, the gestalt layer 320 and the asset layer 330 form together an association processor 500.

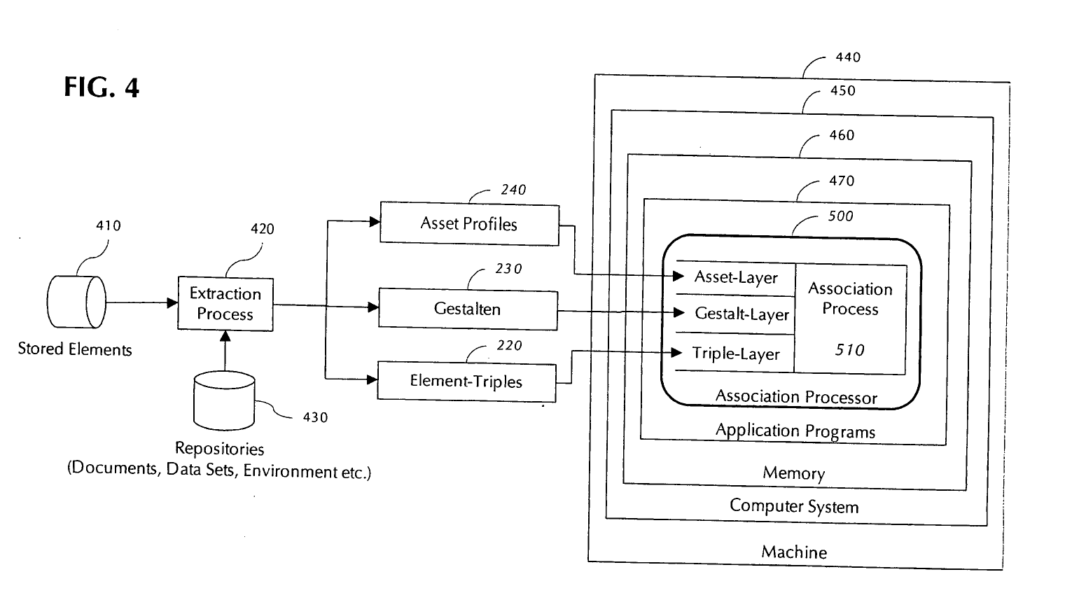

The association processor 500 is shown in FIG. 4 and is the platform for association process 510 and part of application programs 470. Due to performance reasons the association processor 500 is preferably located in a memory 460 of a computer system 450. A machine 440 on which the association processor 500 runs can be either a client computer, a server computer, a security system, a car, a robot or any other system that analyses its environment and has to react with the environment. The connections 117 between the initial elements (elements that are preset by a user) 210 stored in a stored element storage 410 are extracted from repositories 430. The repositories 430 can be, for example, stored documents, data sets of a database, a collection of 3D models or a photo or a video of the machine's environment. Extraction processes 420 create the asset profiles 240 which form the asset-layer 330, the gestalts 250 which form the gestalt-layer 320 and the element-triples 220 that form the triple-layer 310. As explained above, the network of these three layers forms the association processor 500.

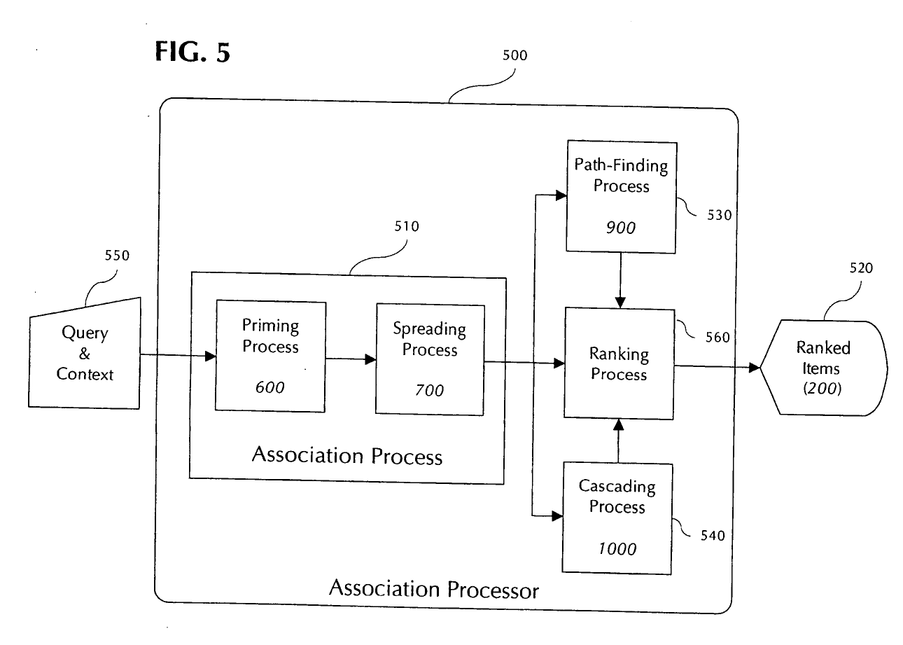

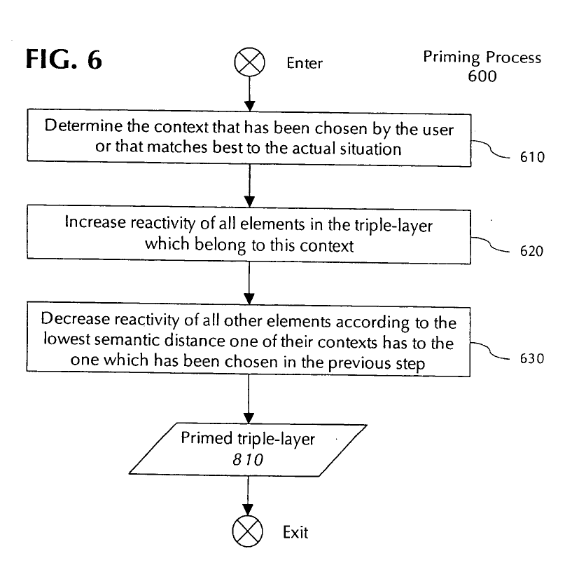

As shown in FIG. 5 in the association processor 500 three methods of the invention take place: an association process 510, a path-finding process 530 and a cascading process 540. The user of the association processor 500 inputs a query and a context (plus, if required, a focus) at input 550 into the association processor 500. The semantic type and query elements are analysed before the association process 510 starts with a priming process 600. The priming process 600 is depicted in FIG. 6 and will be described in more detail later. The priming process 600 involves modulating the reactivity (i.e. the manner of how the element will react to incoming activation) of all of the elements of the triple-layer as a function of the current context. The current context will be, for example, the current situation in which a robot is to be found or it will be the query-context selected by the user. This reactivity of a node (i.e. of the elements in the element triple) is represented by the so-called “priming factor” of the node. The initial values of the reactivity can be all set to a standard value or they can be based on previous experience (e.g. previous searches). Suppose as an example a researcher wishes to investigate the treatment of Parkinsonian Disease and has no pre-existing knowledge, then all of the reactivates are set to the same value as the researcher has no further information initially to guide him or her. If, on the other hand, colleagues of the researcher have already investigated the subject, then some of the reactivity values of the node can be set to higher values as they are regarded as being more significant. The priming process then adjusts the reactivities in order to take into account previously acquired knowledge. In this example, the PubMed database at the US National Institutes of Health might be searched to ascertain publications on the treatment of Parkinsonian Disease and adjust the reactivities.

Similar a robot entering a new environment initially does not understand the new environment. All reactivity values of the nodes are set to the same value and an analysis is made. On the other hand, if the robot has already been in the environment previously, then some of the reactivity values may be set to a higher values as the robot will know the environment. The robot could know the positions of furniture in the room, for example, and the location of the door. Any new items will not have reactivities associated with them. Suppose the robot identifies a new chair in the environment. It will know what a chair is and its function, but will not have “knowledge” about its use in the environment. The priming process will allow the robot to identify the use and function on the chair in the environment.

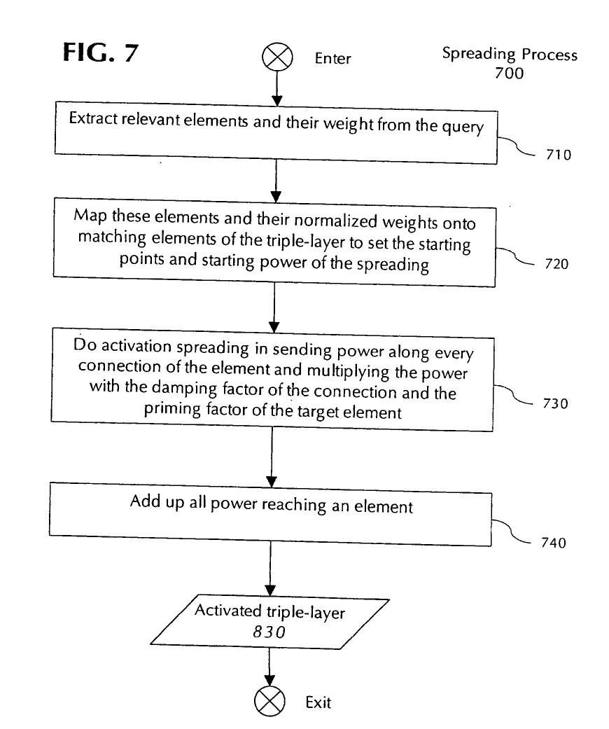

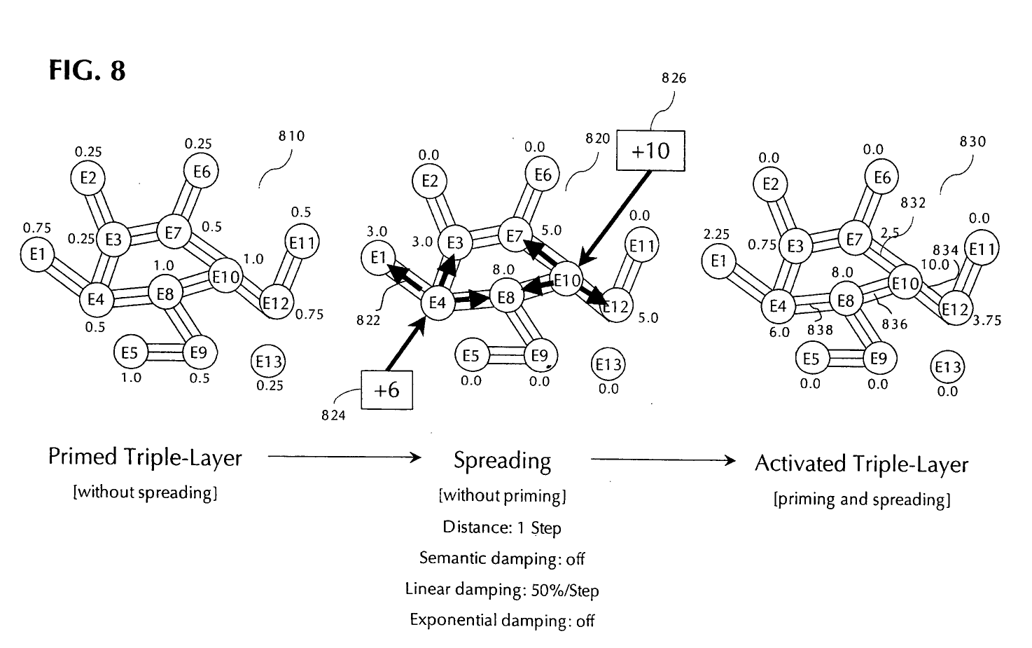

The result of the priming process 600 is a primed triple-layer 810 as is shown in FIG. 8. The primed triple-layer 810 is then used to perform the spreading process 700 (as shown in FIG. 7) starting at those elements of the triple-layer 810 matching onto elements of the query. Suppose a query is entered by the user, then those elements of the triple layer 810 used in the query-text are the starting elements. The query could be “inform me about the relationship between dopamines and Parkinsonian disease”. The elements 210 of the triple layer 810 corresponding to “dopamines” and “Parkinsonian disease” are then selected as the starting elements.

In another example, a command is given to the robot. The parts of the command which match some of the elements 210 in the triple-layer 810 are the starting points. In general it can be said that the priming process 600 represents the current situation (=context and/or focus) and the spreading process 700 is a retrieval process (i.e. the process of ranking elements according to their importance to the actual situation). Because the spreading process 700 is modulated by the priming factors of connections (e.g. 313, 315, 317) and the reactivity of the elements 210 one can say that the retrieval process is steered by the current situation. In doing so the priming process closely links the query and the context. This is an important process in retrieval engines. The result of the priming process 600 and the spreading process 700 is an activated triple-layer 830. On the basis on the activated triple-layer 830 the element-triples can directly be ranked 560. The ranking is carried out in accordance with the activation energy accumulated in the element-triple 810 and presented to the user or to a consciousness-system of the robot 520. To refine the result a graph-theory based path-finding process 530 can recombine the element-triples and give the recombined triple-assemblies a ranking weight. To associate not only element-triples or paths a cascading process 1000 is activated. During the cascading process 1000 the activation energy of the elements is transferred into the asset-profiles and into the gestalts where it is accumulated (i.e. added to the existing energy). The assets and the gestalts are then ranked according to the accumulated energy and presented to the user 520. The quality and differentiating factor of the ranking essentially depends on the priming process 600 and on the spreading process 700.

FIG. 6 shows the main steps of the priming process 600. The priming process 600 generates a primed triple-layer 810 as discussed above. The primed triple-layer 810 represents the context of the query in the association processor 500. This is done by selecting an initial triple-layer and then modulating the reactivity values of all elements 210 in the initial one of the triple-layer 310 to produce a primed triple-layer 810. The reactivity value of the element 210 in the triple-layer 310 determines the way in which the element 210 deals with energy coming in via the connections. In a first step of the priming process, the context of the query has to be determined at step 610. The context is a group of elements (210) which (sometimes combination with the focus) characterizes a situation or meaning. So the context is a thematic group of elements. The elements of the context usually do not belong to the same category. To take an example, consider a context “Clinic” which contains words from the categories like apparatus, workflow, building or part of it and so on. If the user has defined a context the user-defined context is used. Otherwise the system retrieves one of a series of predefined contexts that matches best to the current situation.

The user could define a context relating to the study of Parkinsonian diseases which includes all the terms which might be relevant. Alternatively, an administrator or a previous user may have developed a context which is stored in a library which is accessible by the user. A further example would be a group of all the known elements 210 in a particular picture.

After one or more of the contexts are selected the reactivity of all of the elements 210 in the initial triple-layer that match to this context are increased in step 620. The reactivity of all other elements 210 in the initial triple-layer is decreased. The amount of decrease for any one of the elements 210 depends on the least distance which one of the contexts to which the element is matched has to the current context 630. The one or more contexts to which any one of the elements belongs and the distances from one of the contexts to another one of the contexts are predefined and stored.

The priming process 600 can be refined by adding a focus to the context. The focus is a set of elements 210 belonging to the same one of the categories. The focus could be therefore termed categorical group of elements. For example a category can be a “molecule”, an “apparatus” or a “chronic disease”. If the context and the focus are selected, the elements of the initial one of the triple-layer which belong to both the context and the focus will be primed to give the highest reactivity values. For example: L-dopa, a molecule that is important in the therapy of Parkinson disease, will have a very high reactivity if the triple layer is primed with the context “Parkinson disease” and the focus “molecule”. The result of the priming process is the primed triple-layer 810.

In the example of the robot, the focus could be on all elements having, for example, the colour “red”. In this case, the priming process 600 would give all elements having the colour red a higher reactivity value.

The reactivity values can also be increased (or decreased) to take into account other considerations including, but not limited to, elements actually viewed (or not viewed) by a user, elements that have been highlighted (or clicked on) or elements that have been eliminated. Furthermore the email history and/or the document history of the user can be taken into account.

After the priming process 600 has been completed, the spreading process (as illustrated in FIG. 7) starts. The spreading process 700 represents the query specific part of the retrieval process in the association processor 500. First the relevant elements of the query are identified in step 710. If the query is a free form text input by the user, words are extracted from the free form text input which match to elements 210 of the triple-layer 310. If the user has assigned a keyword weight to the keywords, the keyword weights are normalized. The keyword weights are used as starting values for the spreading process 720.

FIG. 8 illustrates in detail the process of modification spreading. In the primed triple-layer 810 elements E8 and E10 that belong to the current context are set to an initial reactivity value of 1. The other elements of the primed triple-layer 810 have a reactivity value that depends on the semantic distance of their context to the current context. These can either be entered directly by a user (using, for example, an educated guess) or can be obtained from previous work (and previously stored for later retrieval). This means that the elements with the reactivity value near to 1 belong to a context that is similar to the current context.

Consider elements E1 and E12. Both of these elements E1 and E12 have the reactivity value 0.75 and therefore belong to the similar context (but, of course, not to the current context—in this case they would have a reactivity value of 1). The elements with the small reactivity values are the elements that belong to a different context than the current one. Examples are the elements E6 and E3 which have the reactivity value 0.25. It should be noted that in the primed triple-layer 810 no element of the network has any modification energy associated with the element. The context of the query is only encoded in the reactivity values of the elements. The modification energy is therefore zero on all of the elements in the network 810. The spreading process 820 of the modification energy start at the elements in the primed triple layer 810 that match to the query elements. In the illustrated example these matched elements are the elements E4 and E10. In the example the user had set the modification energy of E4 to +6 in step 824 and the modification energy of E10 to +10 in step 826.

The modification energy is obtained in one example from the query input by the user. The user wishes to research the relationship between Parkinsonian Disease, Dopamines and Clinics. The most important term in the query is Parkinsonian disease and this is associated with a high modification energy. The next most important term is dopamines and the modification energy is lower. The least important term is clinics which has a lower modification energy.

In robots, the modification energy is based upon the command. “Pick-up cup from table” would create initial modification energies for the elements of the command “pick-up”, “cup” and “table”. If the user wanted to emphasise that the cup needed to be picked up from the table and added emphasis to the voice when mentioning the word “table”, this would add extra modification energy to “table”.

The sign of the modification energy could also be negative. This could happen if the user wanted to de-emphasise something. For example the robot might be instructed to pick up the cup from the table, but not from the chair. Negative modification energy would be added to the element “chair”.

The spreading modification is an inhibition or an activation of the elements of the network. When starting the retrieval process the spreading of modification energy begins along the connections from the starting points (i.e. from the elements that match to the query elements, in FIG. 8 these are the elements E4 and E10). Crossing one of the connections reduces the modification energy according to a user-defined damping factor. In the example there is only a linear damping factor of 50%. Let us consider the element E1 which is separated by a single connection from the starting element E4. It will be recalled that E4 has a starting modification energy of 6. The resulting modification energy of element E1 as adjusted in step 822 is therefore 50% of 3 as one connection is traversed is proceeding from the element E4 to the element E1. The resulting modification energy is then multiplied with the priming factor of the element. To return to the example the priming factor of E1 is 0.75 so the resulting activation of the element E1 is 3×0.75=2.25. The damping factor can be adjusted in a number of ways. For example, it could be calculated from the context chosen by the user or be a function of the semantic structure of the query and the semantic structure of the correction. It could be a linear or exponential function.

Let us take the example that one element is reached by more than one spreading modification. In this case, the activations are added. Consider the element E8 in 820. The element E8 receives a modification energy of 3 from the starting element E4 (one connection traversed) and a modification energy of 5 from the starting element E10 (one connection traversed). The modification energies are multiplied with the priming factor of element E8 which is 1. The resulting activation is (5+3)×1=8. The activation of the element-triple is calculated based on the sum of the activations of the two elements in the element-triple. It is now possible to rank the element-triples. The top three element-triples are: element triple E8-E10 836 with an activation of 10+8=18, element triple E8-E4 838 with an activation of 8+6=14 and element triple E12-E7 834 with an activation of 10+3.75=13.7. The result of the association process is a list of ranked element-triples. Each of the element-triples can be regarded as information. The first result of the association process is therefore ranked information.

It will be helpful in the understanding of the invention to bear the following two facts in mind: The first point is that the activated triple-layer 830 the element E1 has a much higher activation value (2.25) than the element E3 (0.75) although they both received the same amount of activation power (modification energy over one connection=3 as described above) during the spreading process 820 as they are above one connection away from the matched element E4. This is because the element E1 fits better to the current context (or focus) than the element E3 and has therefore a better priming factor 810. The second point is that the element E5 has an activation value of 0.0 in the activated triple-layer 830, although its priming factor was the highest possible (1.0) 810. This is because the spreading process did not reach the element E5 820. These two facts show the principle of the invention: only if the elements fit to the current situation and are quite near the elements of the query or task, they then accumulate the activation power. This effect is enhanced if not only the spreading of the activation is used but also the spreading of the inhibition. In this case the element in order to accumulate activation energy must be near to one of the activating elements and far away from the inhibiting elements, as well as belonging to the context and/or to the focus. These factors form together a powerful method to steer the retrieval process.

The activated triple-layer is not only used for ranking information as described above. This activation of the elements steers the path finding process 900. The path finding process 900 generates interesting assemblies of information. The activation of the elements is also used by the cascading process 1000 for associating and ranking larger information-units like gestalts and assets.

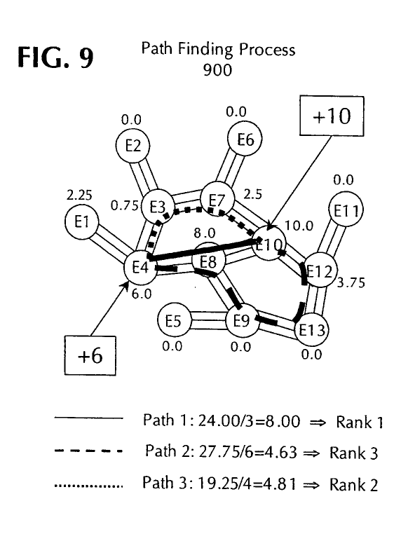

The path finding process 900 as illustrated in FIG. 9 uses standard graph algorithms to calculate paths between two or more elements of the activated triple-layer. In the example of FIG. 9 there are three paths in total between the elements E4 and E10. Path 1 is between the element E4 and the element E10 via the element E8. Path 2 is via the elements E3, E7 and E10. Path 3 (the longest path) is via the elements E8, E9, E13 and E12. The mean activation for the element of the path is calculated for each of these three paths. Path 1 has an activation of 24 (6+8+10) which is the sum of the activations of each of the elements in the path. Path 2 has an activation of 27.75 (i.e. 6+0.75+2.5+10) and path 3 has an activation of 19.25 (6+8+0+0+3.75+10). The mean activation is this sum divided by the number of elements in the path. So path 1 has a mean activation of 8, path 2 of 4.63 and path 3 of 4.81. The path with the best ratio of accumulated activation and length is the path with the highest rank (in this case path 1). Introducing the semantic distance between the succeeding element-triples within the path can refine this method.

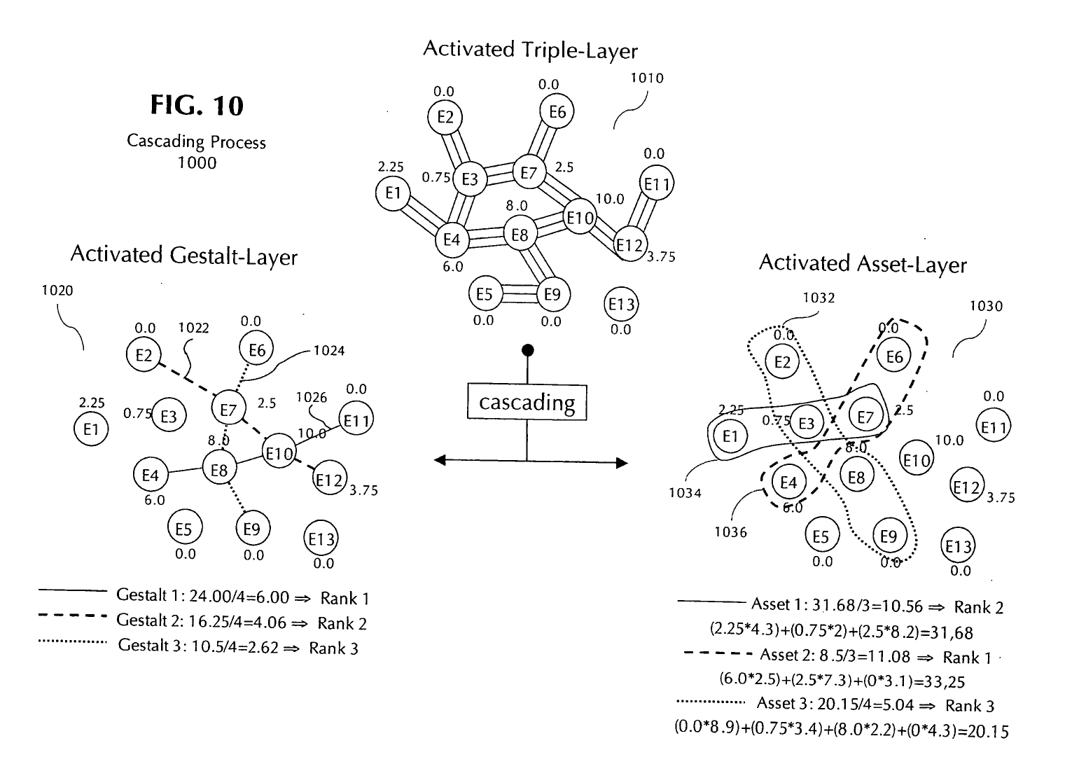

The cascading process 1000 as shown in FIG. 10 is used to associate and rank not only element-triples but also bigger element-assemblies like gestalts 230 and asset-profiles 240. This is done by activating the gestalt-layer 320 and the asset-layer 330 after the activation spreading in the triple-layer has finished.

It will be recalled that the gestalt-layer 320 and the asset-layer 330 use the same elements 210 as the triple-layer 310. The activation of the elements 210 in the triple-layer 310 can now be transferred to the corresponding elements of 210 the gestalt-layer 320 and the asset-layer 330. The elements 210 are grouped by the gestalten 230 and the asset-profiles 240 as is shown in FIG. 10. In the activated gestalt-layer 1020 the mean activation per element is calculated for all the gestalts 230 with at least one activated element. The gestalts are ranked according to their mean activation which is defined above. In the activated asset-layer 1030 all of the asset profiles 240 with at least one activated element are identified. Every one of the elements 210 within an asset profile 240 has a weighting-factor which expresses the importance of the element 210 for characterizing the asset profile 240. The activation energy of the element 210 is multiplied with this weighting-factor. This is done for each element of the asset profile 240. After that the mean value for each ones of the element 210 in the asset profile 240 is calculated. This mean value is used for ranking the asset profile 240.

New gestalts can also be created using this system. In a first step of the creation of a new gestalt, a defined number of paths between the elements is calculated using graph algorithms. The sum of the activation and the mean value of the activation are then created along the calculated path. The newly calculated path can than be ranked according either to the sum of the activations or to the mean activation along the path. A critical value can be defined above which it is assumed that a gestalt exists along the path. If the sum of the activation or the mean activation is below this critical value, it is assumed that no new gestalt has been created.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. An apparatus for use in an information retrieval system comprising:
a processor; and
a memory storing a plurality of information elements, wherein the memory further stores:
a plurality of connections between at least two of the plurality of information elements to form an element connection;
one or more gestalts comprising a plurality of the information elements related to each other; and
one or more asset-profiles comprising a plurality of the information elements with weighted values.

2. The apparatus of claim 1, wherein each of the plurality of the information elements represents concepts in a document.

3. The apparatus of claim 1, wherein each of the plurality of the information elements represents one or more pixels in an image.

4. The apparatus of claim 1, wherein each of the plurality of the information elements represents one or more parts of a frame model.

5. The apparatus of claim 1, wherein the connections between two of the plurality of the information elements is a heuristic connection.

6. The apparatus of claim 1, wherein the connections between two of the plurality of information elements represents a semantic connection.

7. The apparatus of claim 1 further comprising an association processor for adjusting the weighted values of the plurality of information elements

8. The apparatus of claim 1 comprising an input processor for accepting a query and generating query elements from the query.

9. The apparatus of claim 8, wherein the association processor matches the query elements with one or more of the plurality of information elements and modifies the weight of individual one of the plurality of information elements.

10. The apparatus of claim 1 further comprising an output device for calculating the values of the element connections from the weights of the information elements making up the at least one element connection and ranking the element-triples.

11. The apparatus of claim 1 further comprising an output device for calculating the average weights of the one or more gestalts and ranking the one or more gestalts.

12. The apparatus of claim 1 further comprising an output device for calculating the average weight of the one or more asset-profiles and ranking the one or more asset-profiles.

13. A method for use in an information retrieval system comprising:
a first step of creating at least one connection between at least two of the information elements representing information to form at least one element connection
a second step of creating at least one gestalt from at least two information elements with a common relationship; and
a third step of creating at least one asset-profile from at least two information elements and assigning each of the at least two information elements a weighted value.

14. The method of claim 13, wherein each of the plurality of the information elements represents concepts in a document.

15. The method of claim 13, wherein each of the plurality of the information elements represents one or more pixels in an image.

16. The method of claim 13, wherein each of the plurality of the information elements represents one or more parts of a frame model.

17. The method of claim 13, further comprising a step of modifying the weights of the at least one connection between two information elements based on a context.

18. The method of claim 13, further comprising a step of modifying the weights of the at least one connection between two of the information elements based on a focus of interest.

19. The method of claim 13, further comprising a step of defining query elements from a query wherein each of the query elements has a modification energy.

20. The method of claim 18, further comprising matching at least one of the query elements to one or more of the information elements.

21. The method of claim 20, further comprising a step of modifying the weights of at least one of the information elements using the modification energy.

22. The method of claim 20, further comprising a step of producing a ranked list of element connections based on the combined weights of the information elements.

23. The method of claim 19, wherein the step of modifying the weights of the information elements comprises a step of traversing the connections from the matched one of the information elements to other ones of the information elements and modifying the weight of the information element based on the modification energy and the number of traversed connections.

24. The method of claim 21 further comprising a step of producing a ranked list of gestalts based on the mean weights of the information elements in the gestalts.

25. The method of claims 21 further comprising a step of producing a ranked list of asset-profiles based on the mean weights of the information elements in the asset-profiles.
